(19) United States
(12) Patent Application Publication
(10) Pub. No.: US 2004/0154195 A1
(43) Pub. Date: Aug. 12, 2004

(54) Combined hanger and greeting card keepsake and method of making

(76) Inventors: Jeri C. Jewell, California, MD (US); John C. Jewell, California, MD (US)

Correspondence Address: LITMAN LAW OFFICES, LTD., P.O. BOX 15035 CRYSTAL CITY STATION, ARLINGTON, VA, 22215, US

(21) Appl. No.: 10/359,261

(22) Filed: Feb. 6, 2003

(51) Int. Cl. G09F 1/00

(52) U.S. Cl. 40/124.01; 40/673

(57) ABSTRACT

A combined hanger and greeting card keepsake with a double-sided display having a substrate with a first side and a second side, a first indicia on the first side, and a second indicia on the second side. The first indicia and the second indicia have a common greeting card theme, and the combined hanger and greeting card keepsake conforms with standard postal regulations for first class mail or the like. Also, an envelope combined with the combined hanger and greeting card keepsake. The envelope has a third indicia which has the common greeting card theme. Further, a method of making the combined hanger and greeting card keepsake.

### BACKGROUND OF THE INVENTION

1. Field of the Invention

The present invention relates to a combined hanger and greeting card keepsake and method of making the same.

2. Description of the Related Art

Many devices have been proposed for the purpose of displaying a message on a hanger to be hung from a door. However, these devices are often utilitarian in nature, not adapted for use as a greeting card or a keepsake, and not adapted to be mailed in conformance with standard postal regulations using first class mail or the like. Also, known greeting cards are not adapted to be hung from a door handle or the like.

A variety of devices have been proposed for displaying a message on a hanger to be hung from a door and, separately, for greeting card designs. Several U.S. design patents have been proposed as follows: U.S. Des. Pat. No. 280,646, issued Sep. 17, 1985 to Howard et al., describes a doorknob privacy sign. U.S. Des. Pat. No. 316,877! issued May 14, 1991 to Mitchell, describes a card holder. U.S. Des. Pat. No. 390,882, issued Feb. 17, 1998 to Ho, describes a set of doorknob notepaper dispensers.

U.S. Des. Pat. No. 408,865, issued Apr. 27, 1999 to Link et al., describes a reflective identification tag. U.S. Des. Pat. No. 413,356, issued Aug. 31, 1999 to Ingram, describes a sleeping baby doorknob sign. U.S. Des. Pat. No. 415,526, issued Oct. 19, 1999 to Ho, describes an erasable door knob tag with marker-pen slot.

U.S. Des. Pat. No. 427,640, issued Jul. 4, 2000 to Derentz, describes a hanging verse card. U.S. Des. Pat. No. 429,286, issued Aug. 8, 2000 to Luciani et al., describes a parking permit holder. U.S. Des. Pat. No. 456,703 S, issued May 7, 2002 to Sornsriwichai, describes a combined door stop and door hung sign.

Also, several U.S. utility patents have been proposed as follows: U.S. Pat. No. 1,430,641, issued Oct. 3, 1922 to Ginn, describes a tag. U.S. Pat. No. 2,305,426, issued Dec. 15, 1942 to Howell, describes a circular doorknob hanger. U.S. Pat. No. 4,216,598, issued Aug. 12, 1980 to Newbert, describes a releasably securable door knob tag.

U.S. Pat. No. 4,309,835, issued Jan. 12, 1982 to Naeve, describes a foldable frame structure. U.S. Pat. No. 4,462,175, issued Jul. 31, 1984 to Romberger, describes a safety tag holder. U.S. Pat. No. 4,862,617, issued Sep. 5, 1989 to Cooke, Jr. et al., describes a detachable message-carrying device.

U.S. Pat. No. 4,968,540, issued Nov. 6, 1990 to Linsenbigler, describes an adhesive securement strip for bows and greeting cards. U.S. Pat. No. 6,219,949 B1, issued Apr. 24, 2001 to Pang, describes a door reminder. U.S. Pat. No. 6,290,261 B1, issued Sep. 18, 2001 to Waggoner et al., describes a shipment form including reusable adhesive.

Further, a couple of printed U.S. patent applications have been proposed as follows: U.S. Patent Application Publication 2002/0066216 A1, published Jun. 6, 2002 to DeLaCruz, describes a baby birth announcement. U.S. Patent Application Publication 2002/0162199 A1, published Nov. 7, 2002 to Notomi, describes a decorative ribbon forming device, and decorative ribbon forming and mounting device.

A couple of British patent spacifications have been proposed as follows: United Kingdom Patent Specification No. 270,753, issued Jun. 2, 1927 to Sayler, describes improvements in and connected with hanks of yarn and the like. United Kingdom Patent Specification 879,623, issued Oct. 11, 1961 to Alfred Stanley & Sons Limited, describes improvements in hanging tabs.

Finally, the following references were printed from the Internet: “Door Knob Hangers,” Plastic Graphics Company, 1 page, printed Nov. 22, 2002. “Fun Doorknob Hangers,” Sue Penrod, 2 pages, printed Nov. 22, 2002. “Doorknob Hangers,” Papemelroti Gift Shop, 2 pages, printed Nov. 22, 2002.

“Doorknob Hangers,”¹ Cross & Oberlie, 2 pages, printed Nov. 22, 2002. “Halloween Printable Activities,” DLTK's Crafts for Kids, 3 pages, printed Nov. 22, 2002. “Thanksgiving Printable Activities,” DLTK's Crafts for Kids, 3 pages, printed Nov. 22, 2002.

None of the above inventions and patents, taken either singularly or in combination, is seen to describe the instant invention as claimed. Thus a combined hanger and greeting card keepsake and method of making the same solving the aforementioned problems is desired.

### SUMMARY OF THE INVENTION

The present invention is directed to a combined hanger and greeting card keepsake and method of making the same. Specifically, the combined hanger and greeting card keepsake is provided with a double-sided display and comprises a substrate with a first side and a second side, a first indicia on the first side, and a second indicia on the second side. The first indicia and the second indicia have a common greeting card theme, and the combined hanger and greeting card keepsake conforms with standard postal regulations for first class mail or the like.

Also, the present invention is directed to an envelope combined with the combined hanger and greeting card keepsake. The envelope has a third indicia which shares the common greeting card theme. Further, the present invention is directed to a method of making the combined hanger and greeting card keepsake.

Accordingly, it is a principal object of the invention to provide a combined hanger and greeting card keepsake.

It is another object of the invention to provide a combined hanger and greeting card keepsake with a double-sided display.

It is a further object of the invention to provide a combined hanger and greeting card keepsake with a first indicia and a second indicia which share a common greeting card theme.

Still another object of the invention is to provide a combined hanger and greeting card keepsake which conforms with standard postal regulations for first class mail or the like.

It is another object of the invention to provide an envelope combined with a combined hanger and greeting card keepsake, where the combined hanger and greeting card keepsake comprise a first indicia and a second indicia which share a common greeting card theme, and where the envelope has a third indicia which shares the common greeting card theme.

It is a further object of the invention to provide a method of making a combined hanger and greeting card keepsake.

Still another object of the invention is to provide a method of making an envelope combined with a combined hanger and greeting card keepsake.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 shows an environmental, perspective, exploded view of the front side of a combined hanger and greeting card keepsake according to the present invention. Also shown is an environmental, perspective view of the back side of a corresponding envelope which may be used with the combined hanger and greeting card keepsake.

FIG. 2 shows an environmental, perspective, exploded view of the back side of the combined hanger and greeting card keepsake according to the present invention. Also shown is an environmental, perspective view of the front side of the corresponding envelope.

FIG. 3 shows a diagram of the steps of a method of making the combined hanger and greeting card keepsake according to the present invention. Also shown are the steps of a method of making the corresponding envelope.

Similar reference characters denote corresponding features consistently throughout the attached drawings.

### DETAILED DESCRIPTION OF THE PREFERRED EMBODIMENTS

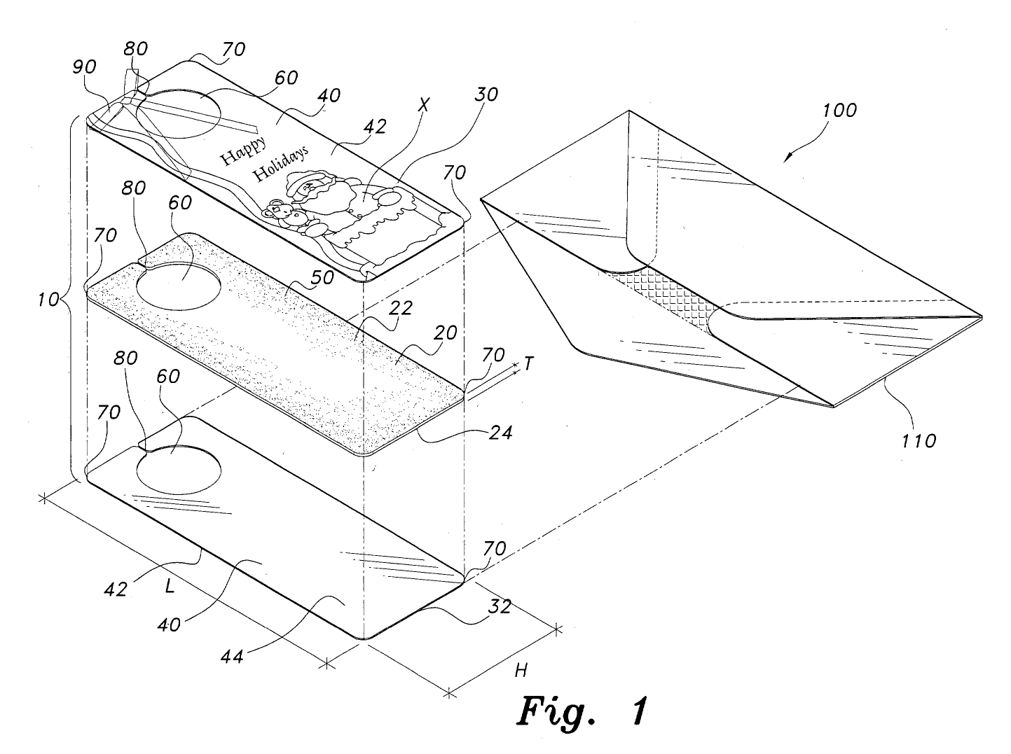

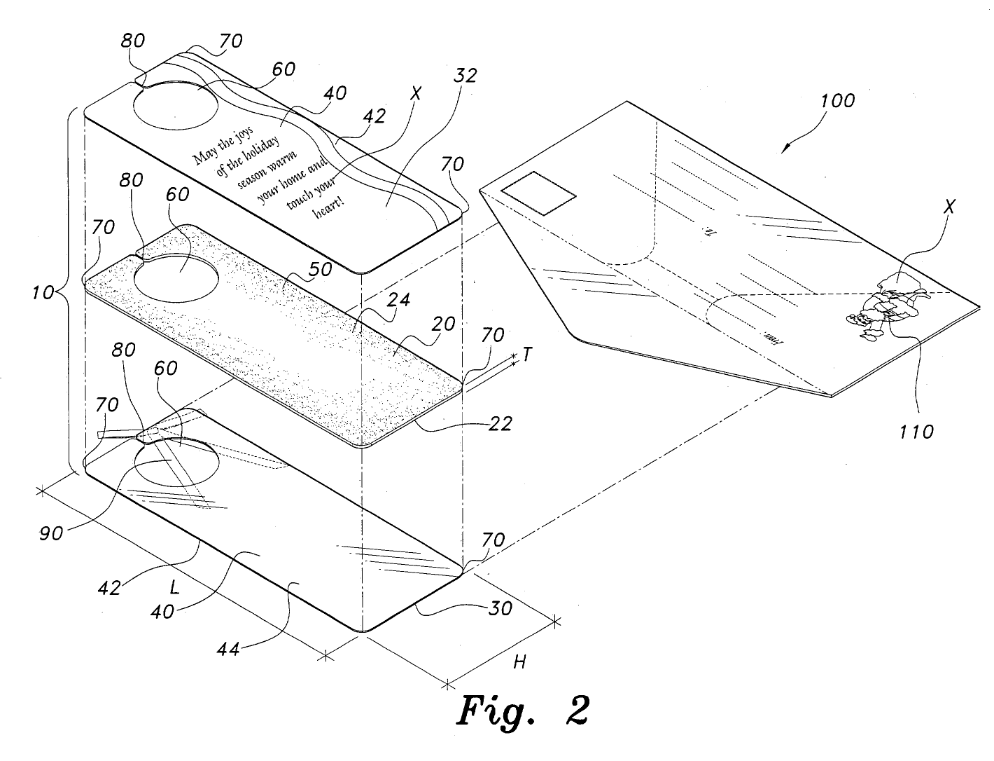

As shown in FIGS. 1 and 2, the present invention is directed generally to a combined hanger and greeting card keepsake 10 with a double-sided display. The present invention is also directed to, in combination 10, 100, a combined hanger and greeting card keepsake 10 with a double-sided display and an envelope 100 adapted to receive the keepsake 10. The present invention is further directed to a method 200 of making a combined hanger and greeting card keepsake 10 with a double-sided display.

The present invention has the advantage of combining the features of a greeting card and keepsake with a hanger which is adapted for hanging from a door handle or the like. The present invention may be used as a gift, and may be adapted for mailing with standard postage and using a standard size envelopes.

Further, compared to a standard greeting card, the present invention uses less paper. The overall size of the present invention may be less than about one-half of that used in forming a standard greeting card. Also, standard greeting cards often require a specially-sized or non-standard envelope.

In a first embodiment, a combined hanger and greeting card keepsake 10 is provided with a double-sided display. The keepsake 10 comprises a substrate 20 with a first side 22 (shown in FIG. 1) and a second side 24 (shown in FIG. 2), a first indicia 30 adapted to be displayed on the first side 22, and a second indicia 32 adapted to be displayed on the second side 24. The first indicia 30 and the second indicia 32 comprise a common greeting card theme X. The keepsake 10 is adapted to conform with standard postal regulations for first class mail or the like.

The substrate 20 may be any suitable material for forming the keepsake 10. Preferably, the substrate 20 is a heavy card stock material, thick paper, posterboard or the like. Other materials may include sheets of plastic, natural materials such as wood, or sheet metal. The substrate 20 may also be a multi-layer material including both an underlying stock layer and at least one surface layer adapted to receive the first and second indicia 30, 32.

The first and second indicia 30, 32 may be displayed on the first and second sides 22, 24 of the substrate 20 using any suitable means of display. For example, the first and second indicia 30, 32 may be printed directly on the first and second sides 22, 24 of the substrate 20. Alternately, the first and second indicia 30, 32 may be printed on a layer 40 which is formed over the substrate 20 as described in detail below with respect to the second embodiment.

As noted above, the first and second indicia 30, 32 comprise a common greeting card theme X. The first and second indicia 30, 32 may be any suitable combination of text and/or graphics. For example, the first indicia 30 may be the image of a character such as Santa Claus and other decorative elements relating, in this case, to a Christmas-related common greeting card theme X. The first indicia 30 may also bear a first text message such as “Happy Holidays” further relating to the Christmas-related common greeting card theme X. In this case, the second indicia 32 would bear similar elements to that of the first indicia 30 that are also related to a Christmas-related common greeting card theme X. The second indicia 32 may further bear a second text message such as a holiday greeting further relating to the Christmas-related common greeting card theme X. As such, the first and second indicia 30, 32 may be the equivalent of the outside and inside of a traditional greeting card, respectively and vice-versa.

The text and/or graphics may be personalized in any suitable manner. The common greeting card theme X may be adapted for any type of greeting such as a holiday, birthday, anniversary, the birth of a child, graduation, wedding, teacher of the year, and the like. In other words, the keepsake 10 of the present invention has all the versatility of the conventional greeting card and the functionality of a hanger.

In order to facilitate personalization, the keepsake 10 of the present invention may be personalized using any appropriate means such as hand-written text and/or graphics or printed text and/or graphics. In particular, a computer and a computer program may be used to design and print personalized greetings onto the keepsake 10 using a desktop printer or the like which is connected to the computer. The present invention may be a part of a kit including software used to print the text and/or graphics on to the keepsake 10 of the present invention. The software may be adapted for a word processing program and/or a graphics program.

In general, the overall size of the keepsake may be adapted for any particular use. If the keepsake 10 is to be inserted into an envelope 100, the size of the keepsake 10 may be varied for different size envelopes. In one preferred embodiment, the keepsake 10 may be adapted to fit inside of a standard legal-sized envelope. In this example, the keepsake is about 8.89 cm (3.5″) high (in the H direction) by about 22.86 cm (9″) long (in the L direction). The keepsake 10 may include an opening 60 with a diameter or greatest width of about 5.08 cm (2″). The opening 60 is typically at the top, but may be provided at any location on the keepsake 10. The keepsake 10 may also be adapted for use as a post card which is about 8.89 cm (3.5″) high by 5″ long.

The shape of the keepsake 10 is shown in the drawings as generally rectangular; however, the keepsake 10 may have any other suitable shape such as circular or a shape which matches the theme X of the greeting card. (Themes are discussed in greater detail below.) For example, a heart-shaped keepsake 10 may be provided for a Valentine's Day keepsake. Also, a tree-shaped keepsake 10 may be provided for Christmas. Other appropriate variations for various greeting card themes are within the scope of the present invention.

The keepsake 10 of the present invention may be laminated to provide additional protection to the keepsake 10. In addition to the protective qualitites of lamination, lamination allows the user of the keepsake 10 to write on the keepsake 10 with an erasable marker or the like.

On the other hand, the keepsake 10 may desirably be free of lamination so that the user may write a personalized message on the surface of the keepsake 10.

A further advantage of the first embodiment is that the keepsake 10 is particularly suited for manufacture using a commercial printing process where, for example, indicia can be printed directly to the surface of the substrate 20. However, as noted above, the scope of the first embodiment includes a keepsake 10 which includes a layer 40 applied to the substrate 20.

The scope of the first embodiment specifically includes all types of standard postal regulations, whether in the U.S. or in another country or region. A standard postal regulation is any set of specifications which defines the proper manner in which mail is transported in a given jurisdiction. First class mail is any standard of mail such as the U.S. designation of first class mail or a similar standard in another jurisdiction.

In the preferred embodiments discussed herein, the overall dimensions of the present invention are intended to conform with standard U.S. postal regulations known to the present inventor at the time of filing the present application. These specific dimensions are discussed in detail in the fourth and fifth embodiments of the present invention. It is understood that these dimensions are subject to change. As such, the present inventor foresees that the dimensions of the present invention may require modification should standard U.S. postal regulations be changed in the future. For example, the U.S. Postal Service publishes U.S. postal regulations. Other known national, regional and international agencies and the like publish similar postal regulations for their respective jurisdictions.

In a second embodiment, the keepsake 10 comprises all the features of the first embodiment, and the keepsake 10 further comprises a layer 40 with a display side 42 and a bonding side 44, the layer 40 being adapted for folding. In the second embodiment, the first and second indicia 30, 32, are printed on the layer 40 and not directly on the substrate 20. Also, the keepsake 10 further comprises an adhesive 50 in contact with the first side 22 (FIG. 1) of the substrate 20, the second side 24 (FIG. 2) of the substrate 20 and the bonding side 44 of the layer 40. The first indicia 30 and the second indicia 32 are adapted to be displayed on the display side 42 of the layer 40.

The layer 40 may be made from any suitable material for displaying the first and second indicia 30, 32. Any suitable type of paper may be used for the layer 40, such as, for example, standard 20# bond paper which is commonly used in the home or office. The layer is desirably made from a material which bonds well with the adhesive 50 and which is well suited for a printing process which may include a desktop printer connected to a computer or a professional printing process such as offset printing. The layer 40 may also be made from materials similar to the substrate 20, such as any suitable type of card stock material, thick paper, posterboard or the like. Other materials may include sheets of plastic, natural materials such as wood, or sheet metal.

During the manufacturing process, the layer 40 may start as one continuous piece of material. After folding and trimming, the layer 40 may be divided into two pieces of material, one for the front side (FIG. 1) of the keepsake 10 and another for the back side (FIG. 2) of the keepsake 10.

The adhesive 50 may be any suitable type of adhesive material for bonding the layer 40 to the substrate 20. The adhesive 50 is preferably first applied to the substrate 20 and then the layer 40 is pressed onto the substrate 20 coated with adhesive 50. However, other suitable methods of applying the adhesive to the substrate 20 and the layer 40 may be used.

The adhesive 50 may desirably be an adhesive glue such as a mounting glue, a spray mount product, or the like. When producing the keepsake 10 by hand, the spray mount product is particularly useful. Spray mount is typically provided in an aerosol can.

After application of the adhesive 50, the layer 40 may be wrapped around the substrate 20. Alternately, the layer 40 may first be trimmed into two pieces and each piece may be applied to the substrate 20.

One advantage of the second embodiment is that the keepsake 10 may be easily assembled by hand. A further advantage is that the keepsake 10 may use a printing technique which is suitable for the layer 40 which may be made of paper, but which might not be appropriate for the substrate 20 which may be made of a thicker material than paper. As such, the keepsake 10 of the second embodiment is particularly suited for use with a printing technique that involves the use of a printing device which is adapted only for printing on thin materials such as paper. In particular, the keepsake 10 of the second embodiment is particularly suited for use with most common computer printers.

In a third embodiment, the keepsake 10 comprises all the features of the first embodiment, and the keepsake 10 is adapted to be inserted into an envelope 100. The envelope 100 comprises a third indicia 110, and the third indicia 110 comprises the common greeting card theme X.

The envelope 100 may be any suitable type of envelope. The envelope 100 desirably has a size which is adapted to receive the keepsake 10 of the present invention. When the layer 40 is used with the present invention, the envelope 100 is desirably made from a material similar or identical to that of the layer 40. In so doing, the keepsake 10 has a desirably uniform appearance as compared to the envelope 100. The shape of the envelope 100 is shown to be generally rectangular; however, any suitable shape may be provided which is appropriate for the keepsake 10. In one preferred embodiment, the envelope 100 is a standard legal-sized envelope adapted to receive a keepsake 10 which is about 8.89 cm (3.5″) high by about 22.86 cm (9″) long. The exact size of the keepsake 10 may be varied to provide an appropriate fit with the envelope 100.

As noted above, the envelope 100 comprises the third indicia 100 with the common theme X. For example, the envelope 100 may include an image of Santa Claus which corresponds with the theme, X displayed on the keepsake 10. The third indicia 110 desirably shares the same features of the first and second indicia 30, 32.

An important advantage of the third embodiment is that the keepsake 10 and envelope 100 may be sent via first class mail or the like. Further, the envelope 100 provides protection for the keepsake 10 during transport or storage.

In a fourth embodiment, the keepsake 10 comprises all the features of the first embodiment, and the keepsake 10 has a height H, a length L, a thickness T, and a weight. The keepsake 10 is similar in size to a letter-sized piece of mail which conforms with standard postal regulations using first class mail or the like. Specifically, the height H is greater than 8.89 cm (3.5″) and less than 15.5575 cm (6.125″), the length L is greater than 12.7 cm (5″) and less than 29.21 cm (11.5″), the height H is not equal to the length L, the length L divided by the height H is greater than 1.3 and less than 2.5, the thickness T is greater than 0.01778 cm (0.007″) and less than 0.635 cm (0.25″), and the weight is less than 28.35 g (1 oz). As such, the keepsake 10 of the fourth embodiment may be mailed with a single stamp for a letter.

In a fifth embodiment, the keepsake 10 comprises all the features of the first embodiment, and the keepsake 10 has a height H, a length L, a thickness T, and a weight. The keepsake 10 is similar in size to a post card-sized piece of mail which conforms with standard postal regulations using first class mail or the like. Specifically, the height H is greater than 8.89 cm (3.5″) and less than 10.795 cm (4.25″), the length L is greater than 12.7 cm (5″) and less than 15.24 cm (6″), the height H is not equal to the length L, the length L divided by the height H is greater than 1.3 and less than 2.5, the thickness T is greater than 0.01778 cm (0.007″) and less than 0.04064 cm (0.016″), and the weight is less than 28.35 g (1 oz). As such, the keepsake 10 of the fifth embodiment may be mailed with a single stamp for a post card.

In a sixth embodiment, the keepsake 10 comprises all the features of the first embodiment, and the keepsake 10 further comprises an opening 60, rounded corners 70, and a slit 80 adjacent to the opening 60.

The opening 60 and the slit 80 allow the keepsake 10 to be hung from an object, such as a door knob, handle or hook. The keepsake 10 may also be adapted to hang, for example, from a rear-view mirror in a car, from a flower stem as a type of greeting card, from a cabinet door knob, from a tree as an ornament, or any other suitable use. Since the keepsake 10 is particularly designed and constructed to be durable, the keepsake 10 may be used repeatedly from year to year. The slit 80 may have any suitable shape, such as a straight linear shape, a curved linear shape, or a jagged linear shape.

The opening 60 may have a shape which corresponds with the theme X. For example, a heart-shaped punch may be used for a keepsake 10 with a Valentine's Day theme, and a four leaf clover-shaped punch may be used for a keepsake 10 with a Saint Patrick's Day theme.

In a seventh embodiment, the keepsake 10 comprises all the features of the first embodiment, and the keepsake 10 further comprises an applique 90. The applique 90 comprises the common greeting card theme X. For example, the applique 90 may be a bow or string with a color in common with the theme X. The applique 90 may be attached to the keepsake 10 using any suitable means of attachment, such as with an adhesive or a staple.

Other suitable types of appliques may be used, such as a leaf shape for a Thanksgiving or Autumn greeting card, a snowflake, a three-dimensional character, or the like, so long as the applique corresponds with the theme X. The applique 90 is desirable in that the applique 90 provides a three-dimensional aspect and an additional graphic element to the keepsake 10. Also, for example, when the applique 90 is a piece of string, the applique 90 may be used to securely fasten the keepsake 10 to the object from which the keepsake 10 is hung, such as a door knob.

In an eighth embodiment, the keepsake 10 comprises all the features of the first, second, third, fourth and sixth embodiments.

In a ninth embodiment, the present invention is directed to, in combination 10, 100, a combined hanger and greeting card keepsake 10 with a double-sided display and an envelope 100 adapted to receive the keepsake 10. Further, the combination 10, 100 comprises all the features of the first and third embodiments.

In a tenth embodiment, the combination 10, 100 comprises all the features of the first, second and third embodiments.

In an eleventh embodiment, the combination 10, 100 comprises all the features of the first, third and fourth embodiments.

In a twelfth embodiment, the combination 10, 100 comprises all the features of the first, third and fifth embodiments.

In a thirteenth embodiment, the combination 10, 100 comprises all the features of the first, third and sixth embodiments.

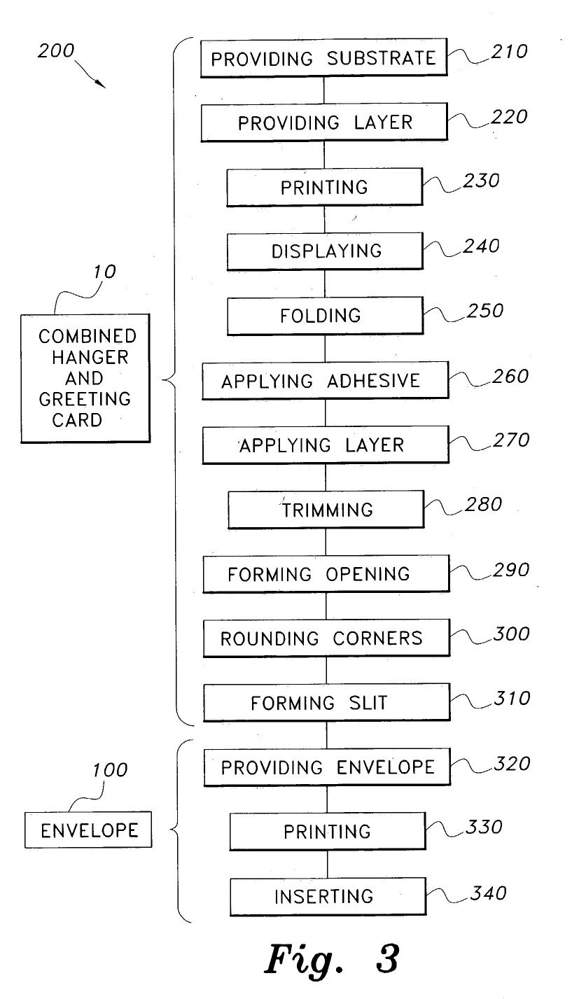

As shown in FIGS. 1, 2 and 3, in a fourteenth embodiment, the present invention is directed to a method 200 of making the keepsake 10 with a double-sided display of the first embodiment. The method 200 (FIG. 3) comprises the steps of providing 210 a substrate 20 with a first side 22 (FIG. 1) and a second side 24 (FIG. 2), printing 230 a first indicia 30 and a second indicia 32, where the first indicia 30 and the second indicia 32 comprise a common greeting card theme X, displaying 240 the first indicia 30 on the first side 22 and the second indicia 32 on the second side 24, and trimming 280 the keepsake 10 such that the keepsake 10 is adapted to conform with standard postal regulations for first class mail or the like. The substrate 20, the first indicia 30, the second indicia 32, the common greeting card theme X, and the standard postal regulations for first class mail or the like are described in detail above.

The substrate 20 may be provided using any suitable means including equipment adapted for mass production. For example, the substrate 20 may be placed upon a working surface using any suitable manual or mechanical means. Once placed upon the working surface, the substrate 20 may be secured in place using any suitable manual or mechanical means.

As noted above, the first and second indicia 30, 32 may be displayed on the first and second sides 22, 24 of the substrate 20 using any suitable means of display including equipment adapted for mass production. For example, the first and second indicia 30, 32 may be printed directly on the first and second sides 22, 24 of the substrate 20. Alternately, the first and second indicia 30, 32 may be printed on a layer 40 which is formed over the substrate 20 as described in detail below with respect to the fifteenth embodiment. Appropriate printing techniques include hand printing, offset printing, and use of a computer printer with a computer. Other suitable methods of printing may be used so long as the first and second indicia 30, 32 are ultimately displayed upon the keepsake 10.

The trimming step 280 may be performed manually using equipment such as a straight edge and/or ruler and a paper cutter. In this case, at least one keepsake 10 is formed at a time. If several keepsakes are stacked on top of one another, then multiple keepsakes may be trimmed simultaneously. The keepsake 10 may also be mass produced using commercial trimming equipment.

In addition, the keepsake 10 may be laminated using any suitable type of laminating equipment including equipment adapted for mass production.

If the keepsake 10 is made manually, the keepsake 10 may be made one at a time, or more than one at a time. In a mass production method, the keepsake 10 may be made by performing each step of the method 200 on one keepsake 10 at a time or on several keepsakes at a time. Also, in a mass production method, the keepsake 10 may be made such that each step of the present method 200 is performed repeatedly one step after another step in a repeating series. For example, an assembly line type method may be used. Further, the steps of the present method 200 may be combined together, as appropriate.

In a fifteenth embodiment, the method 200 comprises all the features of the fourteenth embodiment and is directed to making the keepsake 10 of the second embodiment. As such, the method 200 further comprises the steps of providing 220 a layer 40 with a display side 42 and a bonding side 44, printing 230 the first indicia 30 and the second indicia 32 on the display side 42, folding 250 the layer 40, applying 260 an adhesive 50 to the first side 22 of the substrate 20, and to the second side 24 of the substrate 20, and applying 270 the layer 40 to the substrate 20 such that the adhesive 50 is in contact with the bonding side 44 of the layer 40. The layer 40 and the adhesive 50 are described in detail above.

The layer 40 may be provided using any suitable means including equipment adapted for mass production. For example, the layer 40 may be placed upon a working surface using any suitable manual or mechanical means. Once placed upon the working surface, the layer 40 may be secured in place using any suitable manual or mechanical means.

The folding step 250 may be performed using any suitable means including equipment adapted for mass production. For example, the folding may be performed manually or with mechanical folding equipment. The layer 40 may be folded one at a time or in multiples.

The adhesive 50 may be applied using any suitable means including equipment adapted for mass production. For example, the adhesive 50 may be applied to the substrate 20. For example, the adhesive 50 may be applied using a can of spray mount. The spray mount may be an adhesive in a can which is sprayed from the can using an aerosol propellant or the like. The adhesive 50 may also be applied with spraying equipment adapted for mass production.

The layer 40 may be applied to the substrate 20 using any suitable means for pressing the layer 40 against the substrate 20 so as to bond the layer 40 to the substrate 20 including equipment adapted for mass production. The applying step 270 may be performed manually or with equipment. For example, the layer 40 may be wrapped around the substrate 20 by hand or with a machine adapted for pressing one piece of material against another.

In a sixteenth embodiment, the method 200 comprises all the features of the fourteenth embodiment and is directed to making the keepsake 10 of the third embodiment. As such, the method 200 further comprises the steps of providing 320 an envelope 100, printing 330 a third indicia 110 on the envelope 100, where the third indicia 110 comprises the common greeting card theme X, and inserting 340 the keepsake 10 into the envelope 100. The envelope 100 and the third indicia 110 are described in detail above. The envelope 100 may be manufactured using any suitable means including equipment adapted for mass production. The third indicia 110 may be displayed on the envelope 100 using any suitable method, such as a printing process including equipment adapted for mass production. The printing process may be similar to the printing step 230 described above.

In a seventeenth embodiment, the method 200 comprises all the features of the fourteenth embodiment and is directed to making the keepsake 10 of the fourth embodiment. As such, the method 200 further comprises the steps of trimming 280 a height H of the keepsake 10 such that the height H is greater than 8.89 cm (3.51″) and less than 15.5575 cm (6.125″), trimming 280 a length L of the keepsake 10 such that the length L is greater than 12.7 cm (5″) and less than 29.21 cm (11.5″), trimming 280 the height H and length L of the keepsake 10 such that the height H is not equal to the length L, trimming 280 the height H and length L of the keepsake 10 such that length L divided by the height H is greater than 1.3 and less than 2.5, providing 210 the substrate 20 with a thickness T which is greater than 0.01778 cm (0.007″) and less than 0.635 cm (0.25″), and providing 210 the substrate 20 with a weight which is less than 28.35 g (1 oz) after the trimming steps 280. The dimensions of the keepsake 10 are described in detail above.

In an eighteenth embodiment, the method 200 comprises all the features of the fourteenth embodiment and is directed to making the keepsake 10 of the fifth embodiment. As such, the method 200 further comprises the steps of trimming 280 a height H of the keepsake 10 such that the height. H is greater than 8.89 cm (3.5″) and less than 10.795 cm (4.25″), trimming 280 a length L of the keepsake 10 such that the length L is greater than 12.7 cm (5″) and less than 15.24 cm (6″), trimming 280 the height H and length L of the keepsake 10 such that the height H is not equal to the length L, trimming 280 the height H and length L of the keepsake 10 such that length L divided by the height H is greater than 1.3 and less than 2.5, providing 210 the substrate 20 with a thickness T which is greater than 0.01778 cm (0.007″) and less than 0.04064 cm (0.016″), and providing 210 the substrate 20 with a weight which is less than 28.35 g (1 oz) after the trimming steps. The dimensions of the keepsake 10 are described in detail above.

In a nineteenth embodiment, the method 200 comprises all the features of the fourteenth embodiment and is directed to making the keepsake 10 of the sixth embodiment. As such, the method 200 further comprises the steps of forming 290 an opening 60 in the substrate 20, rounding 300 the corners 70 of the keepsake 10, and forming a slit 80 adjacent to the opening 60. The opening 60, the rounded corners 70, and the slit 80 are described in detail above.

The opening 60 may be produced using any suitable means of forming an opening in the keepsake 10 including equipment adapted for mass production. For example, in a manual production method, an art punch, such as the kind found at craft stores, may be used. In a mass production method, an automated punch may be used. The automated punch may be adapted for simultaneously punching multiple keepsakes.

The rounded corners 70 may be produced using any suitable means of forming rounded corners 70 on the keepsake 10 including equipment adapted for mass production. For example, in a manual production method, scissors may be used. In a mass production method, a automated cutting device may be used. The automated cutting device may be adapted for simultaneously cutting multiple keepsakes.

The slit 80 may be produced using any suitable means of forming the slit 80 in the keepsake 10 including equipment adapted for mass production. For example, in a manual production method, scissors may be used. In a mass production method, an automated cutting device may be used. The automated cutting device may be adapted for simultaneously cutting multiple keepsakes.

In a twentieth embodiment, the method 200 comprises all the features of the fourteenth, fifteenth, sixteenth, seventeenth and nineteenth embodiments and is directed to making the keepsake 10 of the eighth embodiment.

It is to be understood that the present invention is not limited to the embodiments described above, but encompasses any and all embodiments within the scope of the following claims.

We claim:

1. A combined hanger and greeting card keepsake with a double-sided display, the combined hanger and greeting card keepsake comprising:
a substrate with a first side and a second side;
a first indicia adapted to be displayed on the first side; and
a second indicia adapted to be displayed on the second side;
wherein the first indicia and the second indicia comprise a common greeting card theme; and
wherein the combined hanger and greeting card keepsake is adapted to conform with standard postal regulations for first class mail or the like.

2. The combined hanger and greeting card keepsake of claim 1, wherein the combined hanger and greeting card keepsake further comprises:
a layer with a display side and a bonding side, the layer being adapted for folding; and
an adhesive in contact with the first side of the substrate, the second side of the substrate and the bonding side of the layer;
wherein the first indicia and the second indicia are adapted to be displayed on the display side of the layer.

3. The combined hanger and greeting card keepsake of claim 1, wherein the combined hanger and greeting card keepsake is adapted to be inserted into an envelope;
wherein the envelope comprises a third indicia; and
wherein the third indicia comprises the common greeting card theme.

4. The combined hanger and greeting card keepsake of claim 1, wherein the combined hanger and greeting card keepsake has a height, a length, a thickness, and a weight;
wherein the height is greater than 8.89 cm (3.5″) and less than 15.5575 cm (6.125″);
wherein the length is greater than 12.7 cm (5″) and less than 29.21 cm (11.5″);
wherein the height is not equal to the length;
wherein the length divided by the height is greater than 1.3 and less than 2.5;
wherein the thickness is greater than 0.01778 cm (0.007″) and less than 0.635 cm (0.25″); and
wherein the weight is less than 28.35 g (1 oz).

5. The combined hanger and greeting card keepsake of claim 1, wherein the combined hanger and greeting card keepsake has a height, a length, a thickness, and a weight;
wherein the height is greater than 8.89 cm (3.5″) and less than 10.795 cm (4.25″);
wherein the length is greater than 12.7 cm (5″) and less than 15.24 cm (6″);
wherein the height is not equal to the length;
wherein the length divided by the height is greater than 1.3 and less than 2.5;
wherein the thickness is greater than 0.01778 cm (0.007″) and less than 0.04064 cm (0.016″); and
wherein the weight is less than 28.35 g (1 oz).

6. The combined hanger and greeting card keepsake of claim 1, wherein the combined hanger and greeting card keepsake further comprises:
an opening;
rounded corners; and
a slit adjacent to the opening.

7. The combined hanger and greeting card keepsake of claim 1, wherein the combined hanger and greeting card keepsake further comprises an applique;
wherein the applique comprises the common greeting card theme.

8. The combined hanger and greeting card keepsake of claim 1, wherein the combined hanger and greeting card keepsake further comprises:
an opening;
rounded corners;
a slit adjacent to the opening;
a layer with a display side and a bonding side, the layer being adapted for folding; and
an adhesive in contact with the first side of the substrate, the second side of the substrate and the bonding side of the layer;
wherein the first indicia and the second indicia are adapted to be displayed on the display side of the layer;
wherein the combined hanger and greeting card keepsake is adapted to be inserted into an envelope;
wherein the envelope comprises a third indicia;
wherein the third indicia comprises the common greeting card theme;
wherein the combined hanger and greeting card keepsake has a height, a length, a thickness, and a weight;
wherein the height is greater than 8.89 cm (3.51″) and less than 15.5575 cm (6.125″);
wherein the length is greater than 12.7 cm (5″) and less than 29.21 cm (11.5″);
wherein the height is not equal to the length;
wherein the length divided by the height is greater than 1.3 and less than 2.5;
wherein the thickness is greater than 0.01778 cm (0.007″) and less than 0.635 cm (0.25″); and
wherein the weight is less than 28.35 g (1 oz).

9. In combination, a combined hanger and greeting card keepsake with a double-sided display and an envelope adapted to receive the combined hanger and greeting card keepsake, the combined hanger and greeting card keepsake comprising:
a substrate with a first side and a second side;
a first indicia adapted to be displayed on the first side; and
a second indicia adapted to be displayed on the second side;
wherein the first indicia and the second indicia comprise a common greeting card theme;
wherein the combination is adapted to conform with standard postal regulations for first class mail or the like;
wherein the envelope comprises a third indicia; and
wherein the third indicia comprises the common greeting card theme.

10. The combination of claim 9, wherein the combined hanger and greeting card keepsake further comprises:
a layer with a display side and a bonding side, the layer being adapted for folding; and
an adhesive in contact with the first side of the substrate, the second side of the substrate and the bonding side of the, layer;
wherein the first indicia and the second indicia are adapted to be displayed on the display side of the layer.

11. The combination of claim 9, wherein the combination has a height, a length, a thickness, and a weight;
wherein the height is greater than 8.89 cm (3.51″) and less than 15.5575 cm (6.125″);
wherein the length is greater than 12.7 cm (5″) and less than 29.21 cm (11.5″);
wherein the height is not equal to the length;
wherein the length divided by the height is greater than 1.3 and less than 2.5;
wherein the thickness is greater than 0.01778 cm (0.007″) and less than 0.635 cm (0.25″); and
wherein the weight is less than 28.35 g (1 oz).

12. The combination of claim 9, wherein the combination has a height, a length, a thickness, and a weight;
wherein the height is greater than 8.89 cm (3.5″) and less than 10.795 cm (4.25″);
wherein the length is greater than 12.7 cm (5″) and less than 15.24 cm (6″);
wherein the height is not equal to the length;
wherein the length divided by the height is greater than 1.3 and less than 2.5;
wherein the thickness is greater than 0.01778 cm (0.007″) and less than 0.04064 cm (0.016″); and
wherein the weight is less than 28.35 g (1 oz).

13. The combination of claim 9, wherein the combined hanger and greeting card keepsake further comprises:
an opening;
rounded corners; and
a slit adjacent to the opening.

14. A method of making a combined hanger and greeting card keepsake with a double-sided display, the method comprising the steps of:
providing a substrate with a first side and a second side;
printing a first indicia and a second indicia, wherein the first indicia and the second indicia comprise a common greeting card theme;
displaying the first indicia on the first side and the second indicia on the second side; and
trimming the combined hanger and greeting card keepsake such that the combined hanger and greeting card keepsake is adapted to conform with standard postal regulations for first class mail or the like.

15. The method of claim 14, wherein the method further comprises the steps of:
providing a layer with a display side and a bonding side;
printing the first indicia and the second indicia on the display side;
folding the layer;
applying an adhesive to the first side of the substrate, and to the second side of the substrate; and
applying the layer to the substrate such that the adhesive is in contact with the bonding side of the layer.

16. The method of claim 14, wherein the method further comprises the steps of:
providing an envelope,
printing a third indicia, on the envelope, wherein the third indicia comprises the common greeting card theme; and
inserting the combined hanger and greeting card keepsake into the envelope.

17. The method of claim 14, wherein the method further comprises the steps of:
trimming a height of the combined hanger and greeting card keepsake such that the height is greater than 8.89 cm (3.5″) and less than 15.5575 cm (6.125″);
trimming a length of the combined hanger and greeting card keepsake such that the length is greater than 12.7 cm (5″) and less than 29.21 cm (11.5″);
trimming the height and length of the combined hanger and greeting card keepsake such that the height is not equal to the length;
trimming the height and length of the combined hanger and greeting card keepsake such that length divided by the height is greater than 1.3 and less than 2.5;
providing the substrate with a thickness which is greater than 0.01778 cm (0.007″) and less than 0.635 cm (0.25″); and
providing the substrate with a weight which is less than 28.35 g (1 oz) after the trimming steps.

18. The method of claim 14, wherein the method further comprises the steps of:
trimming a height of the combined hanger and greeting card keepsake such that the height is greater than 8.89 cm (3.5″) and less than 10.795 cm (4.25″);
trimming a length of the combined hanger and greeting card keepsake such that the length is greater than 12.7 cm (5″) and less than 15.24 cm (6″);
trimming the height and length of the combined hanger and greeting card keepsake such that the height is not equal to the length;
trimming, the height and length of the combined hanger and greeting card keepsake such that length divided by the height is greater than 1.3 and less than 2.5;
providing the substrate with a thickness which is greater than 0.01778 cm (0.007″) and less than 0.0115.24 cm (6″); and
providing the substrate with a weight which is less than 28.35 g (1 oz) after the trimming steps.

19. The method of claim 14, wherein the method further comprises the steps of:
forming an opening in the substrate;
rounding the corners of the combined hanger and greeting card keepsake; and
forming a slit adjacent to the opening.

20. The method of claim 14, wherein the method further comprises the steps of:
providing a layer with a display side and a bonding side;
printing the first indicia and the second indicia on the display side;
folding the layer;
applying an adhesive to the first side of the substrate, and to the second side of the substrate;
applying the layer to the substrate such that the adhesive is in contact with the bonding side of the layer;
providing an envelope;
printing a third indicia on the envelope, wherein the third indicia comprises the common greeting card theme; and
inserting the combined hanger and greeting card keepsake into the envelope;
trimming a height of the combined hanger and greeting card keepsake such that the height is greater than 8.89 cm (3.5″) and less than 15.5575 cm (6.125″);
trimming a length of the combined hanger and greeting card keepsake such that the length is greater than 12.7 cm (5″) and less than 29.21 cm (11.5″);
trimming the height and length of the combined hanger and greeting card keepsake such that the height is not equal to the length;
trimming the height and length of the combined hanger and greeting card keepsake such that length divided by the height is greater than 1.3 and less than 2.5;
providing the substrate with a thickness which is greater than 0.01778 cm (0.007″) and less than 0.635 cm (0.25″);
providing the substrate with a weight which is less than 28.35 g (1 oz) after the trimming steps;
forming an opening in the substrate;
rounding the corners of the combined hanger and greeting card keepsake; and
forming a slit adjacent to the opening.
